(19) United States
(12) Patent Application Publication
(10) Pub. No.: US 2016/0133231 A1
(43) Pub. Date: May 12, 2016

(54) DISPLAY DRIVER INTEGRATED CIRCUIT WITH DISPLAY DATA GENERATION FUNCTION AND APPARATUS THEREWITH

(71) Applicant: Novatek Microelectronics Corp., Hsinchu (TW)

(72) Inventors: Shang-I Liu, Kaohsiung City (TW); Li-Chun Huang, Hsinchu City (TW); Ching-Chun Lin, New Taipei City (TW); Chia-Hsin Tung, Hsinchu City (TW); Chien-Yu Chen, Hsinchu County (TW); Hung-Wei Lin, Hsinchu City (TW)

(21) Appl. No.: 14/918,549

(22) Filed: Oct. 20, 2015

Related U.S. Application Data
(60) Provisional application No. 62/077,327, filed on Nov. 10, 2014.

(51) Int. Cl. G09G 5/18

(52) U.S. Cl. CPC G09G 5/18; G09G 2310/08; G09G 2330/021; G09G 2300/04

(57) ABSTRACT

In the disclosure, a display driver integrated circuit (DDIC) configured to drive a display panel and an electronic apparatus having the DDIC would generate display data to constantly update information displayed on the display panel even when a processor is in a power save mode. The DDIC includes a first input terminal, a memory device, an information rendering unit, an information overlay unit, and a source driver. The first input terminal receives a subscribed signal. The memory device stores a background image. The information rendering unit is coupled to the first input terminal of the DDIC to receive the subscribed signal and renders subscribed information according to the subscribed signal. The information overlay unit receives the subscribed information from the information overlay unit and the background image from the memory device, and accordingly, the display data is generated without obtaining frame data from an external processor.

### CROSS-REFERENCE TO RELATED APPLICATION

This application claims the priority benefits of U.S. provisional application Ser. No. 62/077,327, filed on Nov. 10, 2014. The entirety of the above-mentioned patent application is hereby incorporated by reference herein and made a part of this specification.

### BACKGROUND OF THE INVENTION

1. Field of Invention

The invention relates to a display driver. Particularly, the invention relates to a display driver integrated circuit (DDIC) with display data generation function and an apparatus therewith.

2. Description of Related Art

In the image displaying technology, frame data is generate by a processor such as a microcontroller (MCU), application processor (AP), a graphics processing unit (GPU), etc. according to the resolution of a display panel, where the frame data carries information for each pixel of the display panel. For example, the display panel may have a resolution of 1280×720 or any other resolutions. The frame data would include information for each of the 1280×720 pixels that constitute the entire display area of the display panel. After the frame data is generated by the processor, the processor would transmit the frame data to a display driver. The display driver would then convert or translate the frame data into display data and control (or drive) data lines and scan lines of the display panel to display an image corresponding to the display data.

Each time the displayed information of the frame data is updated, the updated frame data would be generated by the processor and transmitted to the display driver as to update the information shown on the display panel. However, the processor consumes a lot of power for generation of the frame data. Furthermore, a data size of the frame data may be large which requires high speed bus to transmit the frame data from the processor to the display driver. The high speed transmission of the frame data would also consume a lot of power.

In an application of a portable or wearable electronic device, power is at scanty. Generation and transmission of the frame data would drain a lot of power each time the information shown on the display panel is updated. For example, the portable electronic device would deplete the power source within a short amount of time if it is to constantly display information on the display panel. Therefore, manufactures have configured the portable electronic devices at the software end, where the portable electronic device is put into sleep mode, power save mode, standby mode or the likes to conserve power. In the sleep mode, power save mode, or standby mode, graphic processing function of the processor is suspended, and the display panel of the portable electronic device would be turned off. In order to view information (e.g., current time) on the display, requests have to be made to wake the processor of the portable electronic device, so that the processor may generate the frame data and transmit the frame data to the display driver for displaying the information on the display panel.

### SUMMARY OF THE INVENTION

In the disclosure, a display driver integrated circuit (DDIC) is provided to constantly update and display information shown on a display panel without constantly obtaining frame data from a processor such as MCU, AP, and etc. that is external to the DDIC. The DDIC would synthesize display data according to subscribed information and a background image. As a result, information shown on the display panel display data may be updated based on the subscribed information even when the processor is in a sleep mode, power save mode, standby mode or the likes, where the graphical process of the processor is suspended or disabled.

In the disclosure, a display driver integrated circuit (DDIC) configured to drive a display panel is provided. The DDIC includes a first input terminal, a memory device, an information rendering unit, an information overlay unit, and a source driver. According to one of the exemplary embodiments of the disclosure, the first input terminal receives a subscribed signal. The memory device stores a background image. The information rendering unit is coupled to the first input terminal and configured to receive the subscribed signal and to render subscribed information according to the subscribed signal. The information overlay unit is configured to receive the subscribed information from the information overlay unit and the background image from the memory device, and accordingly, the information overlay unit generates display data according to the subscribed information and the background image. The source driver is coupled to the information overlay unit to receive the display data and configured to drive data lines of the display panel to display an image corresponding to the display data on a display panel.

According to one of the exemplary embodiments, the DDIC further includes a second input terminal and a timing controller. The second input terminal receives a frame data. The timing controller is coupled to the second input terminal, the memory device, and the information overlay unit, and configured to control timing sequence of the data lines of the display panel and store the frame data to the memory device as the background image. In the exemplary embodiment, the display data is different from the frame data, wherein the display data is updated at a first rate, and the background image is updated by the frame data at a second rate, and the first rate is different from the second rate.

According to one of the exemplary embodiments, the background image is pre-stored in the memory device.

According to one of the exemplary embodiments, the information overlay unit determines a portion of the background image to be updated and generates the display data by overlaying the subscribed information over the portion of the background image.

According to one of the exemplary embodiments, the information rendering unit obtains a graphical representation of the subscribed information through a lookup table according to the subscribed signal.

According to one of the exemplary embodiments, the subscribed signal is an oscillating signal.

According to one of the exemplary embodiments, the DDIC further includes an internal oscillating device generating an internal oscillating signal, and the internal oscillating device is synchronized according to the subscribed signal, and wherein the subscribed information is rendered according to the internal oscillating signal.

According to one of the exemplary embodiments, the subscribed signal is a command instruction, and the information rendering unit renders the subscribed information in response to the command instruction.

In the disclosure, an electronic apparatus is provided. According to one of the exemplary embodiments of the disclosure, the electronic apparatus includes a microprocessor, a display panel, and a display driver integrated circuit (DDIC), coupled to the microprocessor and the display panel. The DDIC renders subscribed information according to a subscribed signal, generates display data according to the subscribed information and a background image, and drives data lines of the display panel according to the display data.

According to one of the exemplary embodiments, the electronic apparatus further includes a sensor hub. The sensor hub is coupled to the DDIC and configured to provide sensing signal from a plurality of sensors to the DDIC as the subscribed signal, wherein the DDIC generates the subscribed information according to the sensing signal.

In order to make the aforementioned and other features and advantages of the disclosure more comprehensible, embodiments accompanying figures are described in detail below.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A illustrates a display system of an electronic apparatus in term of functional block diagram according to one of the exemplary embodiments of the disclosure.

FIG. 1B is schematic diagram illustrating a display area of a display panel according to one of the exemplary embodiments of the disclosure.

FIG. 2 illustrates a display driver integrated circuit (DDIC) 100 in term of functional block diagram according to one of the exemplary embodiments of the disclosure.

FIG. 3 illustrates a lookup table according to one of the exemplary embodiments of the disclosure.

FIG. 4 illustrates a bitmap of the graphical representation of a character according to one of the exemplary embodiments for the disclosure.

FIG. 5 is a block diagram illustrating an overlaying operation of an information overlay unit according to one of the exemplary embodiments of the disclosure.

FIG. 6 illustrates a DDIC coupled to the external processor in term of functional block diagram according to one of the exemplary embodiments of the disclosure.

FIG. 7 illustrates a display system of an electronic device in term of functional block diagram according to one of the exemplary embodiments of the disclosure.

FIG. 8 illustrates a DDIC in term of functional block according to one of the exemplary embodiments of the disclosure.

FIG. 9 illustrates a DDIC in term of functional block diagram according to one of the exemplary embodiments of the disclosure.

FIG. 10 illustrates a display system of an electronic apparatus in term of functional block diagram according to one of the exemplary embodiments of the disclosure.

### DESCRIPTION OF EMBODIMENTS

Reference will now be made in detail to the present embodiments of the disclosure, examples of which are illustrated in the accompanying drawings. Wherever possible, the same reference numbers are used in the drawings and the description to refer to the same or like parts.

No element, act, or instruction used in the detailed description of disclosed embodiments of the present application should be construed as absolutely critical or essential to the present disclosure unless explicitly described as such. Also, as used herein, the singular forms “a,” “an” and “the” are intended to include the plural forms as well, unless the context clearly indicates otherwise. Furthermore, when an element is referred to as being “connected” or “coupled” to another element, it may be directly connected or coupled to the other element or intervening elements may be presented.

In the disclosure, a display driver integrated circuit (DDIC) is provided to constantly update and display information shown on a display panel without constantly obtaining frame data from a processor such as MCU, AP, and etc. that is external to the DDIC. The DDIC would render subscribed information associated to the information shown on the display panel according to an external signal, and then synthesize display data according to the rendered subscribed information and a background image stored in the DDIC. Therefore, the display data may be generated to drive the display panel to constantly update the information shown on the display panel even when the processor is in operated in a sleep mode, a standby mode, a standby mode or the likes, where the graphic processing function of the processor is suspended or disabled in the aforementioned modes.

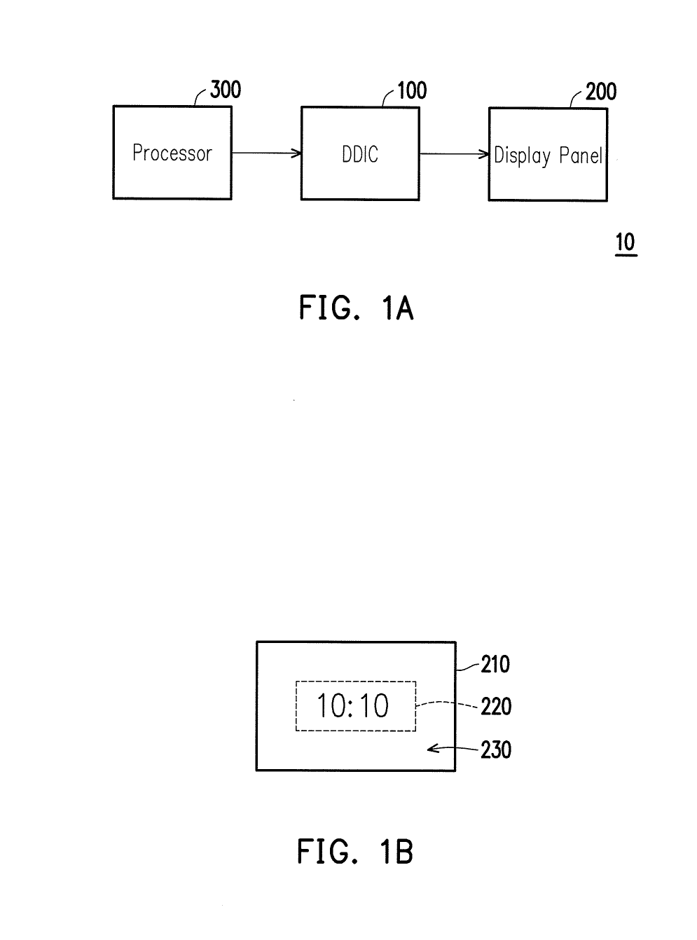

FIG. 1A illustrates a display system of an electronic apparatus 10 in term of functional block diagram according to one of the exemplary embodiments of the disclosure. In the exemplary embodiment, the electronic apparatus 10 may be a smart watch, a smart phone, a computer, or other electronic devices having display function. The electronic apparatus 10 includes a display driver integrated circuit (DDIC) 100, a display panel 200 and a processor 300. In the exemplary embodiment, the DDIC 100 is coupled between the display panel 200 and the processor 300. When the electronic apparatus 10 is operated in a normal operation mode, the DDIC 100 receives frame data from the processor 300 and converts the frame data into display data for driving the display panel 200. In the exemplary embodiment, the display data is different from the frame data. When the electronic apparatus 10 is operated in the sleep mode or standby mode (referred as a power save mode herein after), the graphic processing function of the processor 300 is suspended to conserve power. Thus, no frame data is generated by the processor 300 during the power save mode. The exemplary DDIC 100 would synthesize display data to update the information shown on the display panel 200 according to a subscribed signal SS received from an external source without obtaining the frame data from the processor 300.

FIG. 1B is schematic diagram illustrating a display area 210 of the display panel 200 according to one of the exemplary embodiments of the disclosure. With reference to FIG. 1B, the display area 210 includes information 220 (e.g., time information) and a background 230. In an application of displaying time, continuous update and display the current time would drain a lot of power in the conventional display system (e.g., 300 mA), since the processor 300 generates and transmits new time information to the display driver for displaying the current time every second, minute, or a predetermined time. On the contrary, the DDIC 100 of the exemplary electronic apparatus 10 would render time information 220 and synthesize the display data to update the time information 220 shown in the display area 210 of the display panel 200 without obtaining the frame data from the processor 300. In the exemplary embodiments, the power consumption of the DDIC 100 for generating the display data to update the time information 220 may be 2 mA, which is much less as compared to the generation of the frame data by the processor 300. The experimental values (300 mA and 2 mA) mentioned above are utilized to demonstrate the disclosure, and it is not in any way limiting the disclosure. Since the frame data is not being transmitted constantly to the DDIC 100 for updating the information shown in the display area 210 of the display panel 200, the power utilized for generating and transmitting the frame data from the processor 300 to the DDIC 100 may be conserved.

The display panel 200 may include a display such as a liquid crystal display (LCD), a light-emitting diode (LED) display, a field emission display (FED) or other types of display. The display panel 200 may also include a resistive, a capacitive or other types of touch sensing device which would be integrated as a part of the display panel 200.

In the exemplary embodiment, the processor 300 may include a microcontroller, a North Bridge, a South Bridge, a field programmable array (FPGA), a programmable logic device (PLD), an application specific integrated circuit (ASIC), or other similar device, or a combination thereof. The processor 300 may also include a central processing unit (CPU) or a programmable general purpose or special purpose microprocessor, a digital signal processor (DSP), a graphics processing unit (GPU), an application specific integrated circuit (ASIC), a programmable logic device (PLD), or other similar device or a combination thereof, which is utilized for processing all or partial tasks of the exemplary electronic device 10.

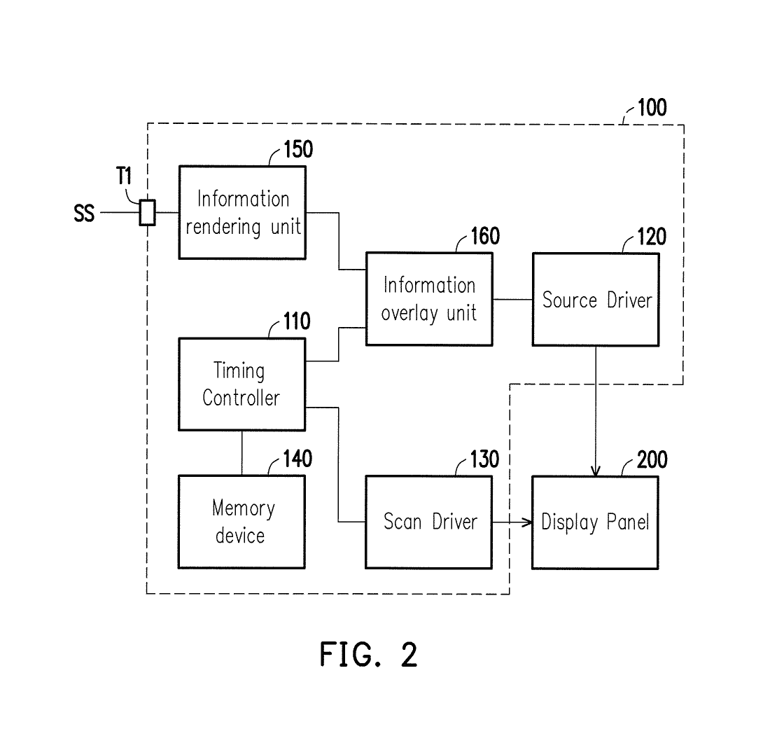

FIG. 2 illustrates a display driver integrated circuit (DDIC) 100 in term of functional block diagram according to one of the exemplary embodiments of the disclosure. The exemplary DDIC 100 includes a timing controller 110, a source driver 120, a scan driver 130, a memory device 140, an information rendering unit 150, and an information overlay unit 160.

The timing controller 110 is coupled to the source driver 120 and the scan driver 130. In the exemplary embodiment, the timing controller 110 transmits control signals to the source driver 120 and the scan driver 130 to control the source driver 120 and the scan driver 130 for transmitting the display data to pixels of the display panel 200. The source driver 120 is configured to drive data lines of the display panel 200 by transmitting data voltages to the data lines according to a timing sequence. The scan driver 130 is configured to drive scan lines of the display panel 200 according to the timing sequence.

The memory device 140 is coupled to the timing controller 130. In the exemplary embodiment, the memory device 140 is coupled to the timing controller 130.

However, in other exemplary embodiments, the memory device 140 may be integrated in the timing controller 110. The memory device 140 stores one or more background image. In the exemplary embodiment, the background image has a resolution complying with the resolution of the display panel 300. For example, if the resolution of the display panel 300 is 1280×720, the resolution of the background image would also be 1280×720 which constitutes the entire display area 210 of the display panel 200. In the exemplary embodiment, the background image may be a black background (e.g., black screen), color background, or an image having any design pattern. In addition, the background image may be pre-stored in the memory device 140 during the manufacture of the DDIC 100. However, the exemplary embodiment is not intended to limit the source of the background image. In one of the exemplary embodiments, the background image is, for example, the frame data previously transmitted from the processor 300. Further description of the background image would be described in details later.

The information rendering unit 150 is coupled to a first input terminal T1 of the DDIC 100 to receive a subscribed signal SS. Based on the subscribed signal SS, the information rendering unit 150 renders subscribed information which is utilized to update the display data. In the exemplary embodiment, the subscribed information may be characters (e.g., alphabets, numbers, punctuations, etc.) or any geometric shapes (e.g., second, minute, and hour hands of an analog clock) that is to be displayed on the display panel 300, and each of the characters or geometric shapes is associated with a graphical representation. The graphical representations may be classified in a lookup table which provides a way for the information rendering unit 150 to obtain the graphical representation of the subscribed information. In other words, the information rendering unit 150 may obtain the graphical representation of the subscribed information according to the subscribed signal SS through the lookup table, and then renders pixels corresponding to the graphical representation of the subscribed information.

In the exemplary embodiment, the lookup table is stored in a memory medium such as RAM, register, etc. However, the disclosure is not limited thereto. In one of the exemplary embodiments, the lookup table may be stored in the memory device 140. Furthermore, the lookup table may be pre-loaded during the manufacturing of the DDIC 100, or installed/updated after the manufacturing or the DDIC 100.

In the exemplary embodiment, the subscribed signal SS may be, but not limiting to, an oscillating signal or a cyclic signal. The information rendering unit 150 may include a timer which counts the number of pluses of the oscillating signal. Then, the information rendering unit 150 determines that the information 220 (e.g., 10:10) shown in the display area 210 of the display panel 200 is required to be updated according to a predetermined number of pulses. For example, ten pluses may be equivalent to one minute. In response to an elapse of ten pulses, a process of rendering the subscribed information may be triggered. In other words, the subscribed signal SS triggers a process of rendering the subscribed information, where the information rendering unit 150 obtains the graphical representation of the subscribed information (e.g., 10:11) through the lookup table.

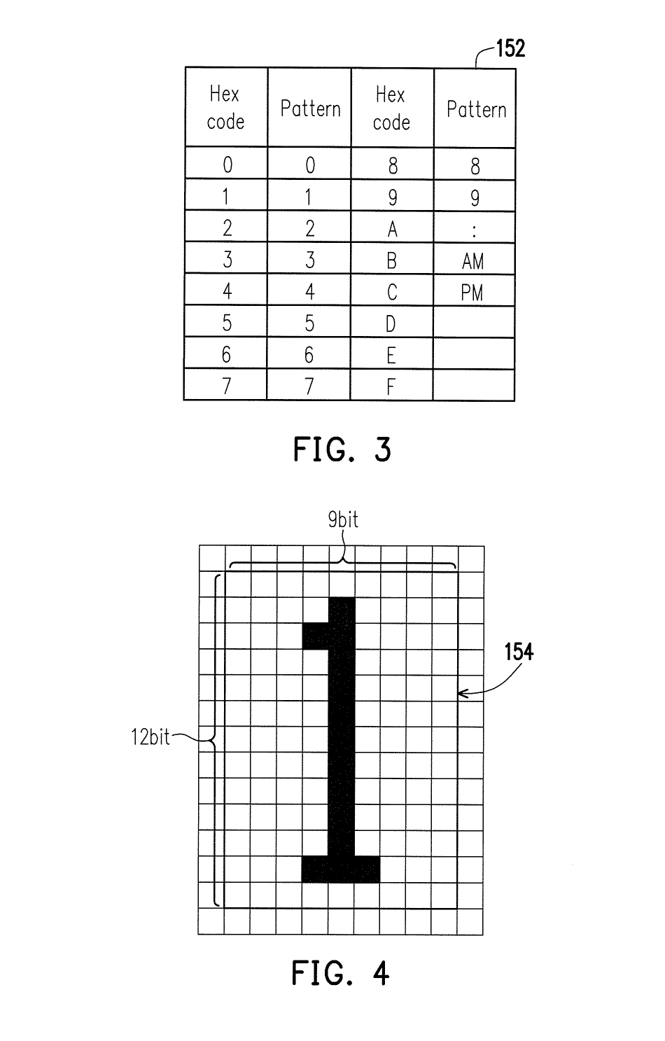

With reference to FIG. 3, an exemplary lookup table 152 utilized for obtaining the graphical representation of the subscribed information is illustrated. In the lookup table 152, each of the graphical representations (i.e., labeled as “pattern”) is mapped to a hexadecimal code. For example, a hexadecimal value of 1 would be associated to the graphical representation of a character “1”. In the exemplary embodiment, the information rendering unit 150 may obtain a hex value corresponding to each character of the subscribed information. According to the hex value, the graphical representation of the subscribed information may be obtained through the lookup table 152.

FIG. 4 illustrates a bitmap of the graphical representation of a character according to one of the exemplary embodiments for the disclosure. In a non-limiting exemplary embodiment, a 9×12 bitmap 154 (108 bits) is utilized to record the graphical representation of each character. For examples, the 9×12 bitmap 154 records the graphical representation (or pattern) of a character “1” by recording pixel information corresponding to each pixel within the bitmap. In the bit map 154, bits corresponding to the shaded pixels are recorded with a value of “1”, and bits corresponding to the non-shaded pixels are recorded with a value of “0”. Furthermore, additional bits may be utilized to record auxiliary functions such as font, alignment coordinate of each bitmaps, color of the character, etc. Moreover, font size of the graphical representation may be changed by scaling up or down the bitmaps.

Referring back to the exemplary DDIC 100 illustrated in FIG. 2, the information rendering unit 150 renders the pixels of the graphical representation corresponding to the characters of the subscribed information. In the exemplary embodiment, every character of the subscribed information may be rendered. In other exemplary embodiments of the disclosure, only the character that is updated relative to the display data that is previously displayed is rendered. For example, when the subscribed signal SS is received indicating that displayed time information 220 is to be update from “10:10” to “10:11”, only the pixels corresponding to the most right digit in the minute section (i.e., a character “0”) would be rendered.

After the subscribed information is rendered, the subscribed information is transmitted to the information overlay unit 160. In the exemplary embodiment, the information overlay unit 160 is coupled to the information rendering unit 150 and the memory device 140 to respectively receive the subscribed information and the background image. According to the subscribed information and the background image, the information overlay unit 160 generates (or synthesizes) the display data. In detail, the information overlay unit 160 determines a portion of the background image to be updated and generates the display data by overlaying the subscribed information over the portion of the background image to be updated.

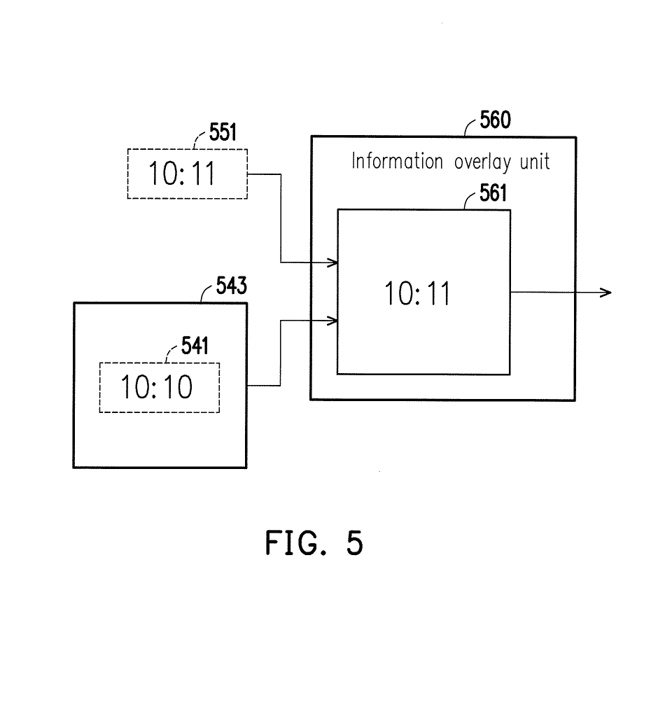

FIG. 5 is a block diagram illustrating an overlaying operation of an information overlay unit 560 according to one of the exemplary embodiments of the disclosure. In the exemplary embodiment, the information overlay unit 560 determines a portion 541 of the background image 543 to be replaced according to the subscribed information 551 received from the information rendering unit 150. For example, the subscribed information 551 may also include an alignment coordinate (e.g., a pixel at top left corner of the subscribed information 220), and the information overlay unit 560 may determine the portion 541 of the background image 543 to be replaced based on the alignment coordinate and dimension of the subscribed information 551 (which may be obtained according to the bitmap). As a result, the information overlay unit 160 synthesizes a frame image 561 by overlaying the portion 541 of the background image 543 with the subscribed information 551 and outputs the frame image 561 as the display data. The exemplary embodiment is not intended to limit the disclosure, any other means for determining a particular coordinate to replace and alignment of images as to synthesize a final image shall fall within the spirit and scope of the disclosure. Furthermore, the characters “10:10” shown within the portion 541 are drawn for illustration only. The background image 543 may be a black or any background without any character within the portion 541.

Next, the information overlay unit 160 transmits the display data to the source driver 120, where the source driver 120 controls the data lines of the display panel 200 for displaying the frame image 561 corresponding to the display data.

In the exemplary embodiment, the information rendering unit 150 and the information overlay unit 160 may be individual processing circuit or one single processing circuit, e.g., processor, logic circuit, etc. In one of the exemplary embodiments of the disclosure, the information rendering unit 150 and the information overlay unit 160 may also be integrated into the timing controller 110.

In the exemplary embodiment illustrated above, the display data is updated by the DDIC 110 with a first update rate while the graphic processing function of the processor 300 is suspended. In other words, without obtaining the frame data from an external processor 300, the DDIC 110 synthesizes the frame image 561 as the display data to update the information 220 shown on the display panel 200 by overlaying the rendered subscribed information 551 over the portion 561 of the background image 543. The first update rate refers to how often the display data is updated. The DDIC may be configured to update the information 220 shown on the display panel 200 every second, every minute, or elapse of a predetermined time. For example, the DDIC may be configured to update time information shown on the display panel 200 every minute. In such case, the first update rate is considered to be 1 minute.

Although the exemplary embodiment of FIG. 5 illustrates the time information in a digital clock format, in one of the exemplary embodiments, the time information may be in an analog clock format. Graphical representation of the subscribed information may be clock hands (second, minute, or hour hands) of an analog clock. The background image may be an analog clock face having dials and/or numbers. When the information shown on the display panel 200 is to be updated, the information rendering unit 150 may obtain a degree corresponding to each of the clock hands according to the subscribed signal SS. The information rendering unit 150 then renders the graphical representation of the clock hands according to the obtained degree of each clock hand. Then, the information overlay unit 160 would synthesize the new display data by overlaying the clock hands over the analog clock face. In the exemplary embodiment, the lookup table may include a graphical representation of each clock hand at every degree of the clock face.

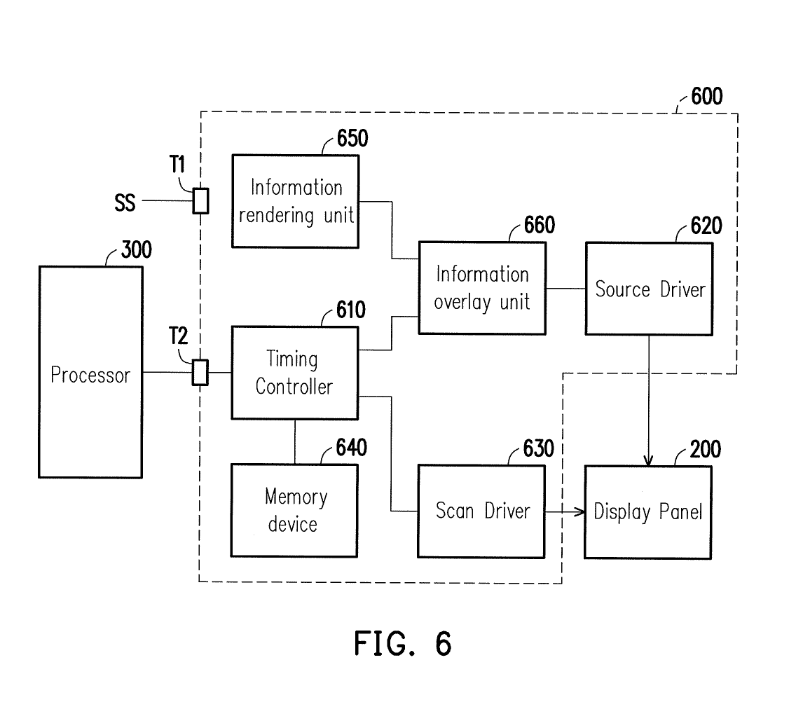

As described previously, the background image may be the frame data of previous frame transmitted from the processor 300. FIG. 6 illustrates a DDIC 600 coupled to the external processor 300 in term of functional block diagram according to one of the exemplary embodiments of the disclosure. In the exemplary embodiment, the operations of a timing controller 610, a source driver 620, a scan driver 630, a memory device 640, an information rendering unit 650, and an information overlay unit 660 are similar to the source driver 120, the scan driver 130, the information rendering unit 150, and the information overlay unit 160 illustrated in FIG. 2, detail description of which are not being repeated here.

In the exemplary embodiment, the DDIC 600 is coupled to the external processor 300 through a second input terminal T2. When the processor 300 is operated in the normal operation mode, frame data generated by the processor 300 is transmitted to the DDIC 600 through the second input terminal T2. The timing controller 610 of the DDIC 600 is coupled to the second input terminal T2 to receive the frame data and store the frame data in the memory device 640. At this time, the frame data received from the processor 300 is stored in the memory device 640 of the DDIC 600 as a background image, which would be referred to as a previously transmitted frame data later for the purpose of illustrated. According to a timing sequence, the frame data is retrieved from the memory device 640 by the timing controller 610 and outputted to the source driver 620 as the display data. Then, the source driver 620 transmits the display data to the data lines of the display panel 200 to display an image corresponding to the display data.

It should be noted that the background image is updated with a second update rate in the exemplary embodiment. The second update rate describes a frequency of the background image being updated by the frame data, or a frequency of a new frame data being stored in the memory device 640 as the background image. In the exemplary embodiment having the black background, the black background is pre-loaded in the memory device 640 during the manufacturing of the DDIC. In such case, the second update rate would be close to zero since the black background may be not updated. In some cases, the update of the black background may occur during a firmware update of the DDIC, however, such update may only occur once a while. In other exemplary embodiments, where the previously transmitted frame data is utilized to update the background image stored in the memory device 640, the background image is only update when the processor 300 exits the power save mode.

In the exemplary embodiment, the first update rate corresponding to the display data is different from the second update rate corresponding to the background image. That is, the display data is updated in a different rate as compared to the update of the background image. As described above, the background image may be updated by the frame data received from the processor 300. In other words, the update rate of the display data is different from the number of times the DDIC would receive the frame data. In one of the exemplary embodiments, the update rate of the display data is greater than the update rate of the background image. Accordingly, power consumption of the DDIC (or the electronic apparatus) is reduced since the DDIC would generate the display data to update the information shown on the display panel more often than the processor would.

Afterward, when the processor 300 may be operated in the power save mode, the DDIC 600 utilizes the previously transmitted frame data as the background image and synthesizes the display data by overlaying newly rendered subscribed information over a portion of the previously transmitted frame data. Accordingly, the display data is generated without obtaining a new frame data from the processor 300.

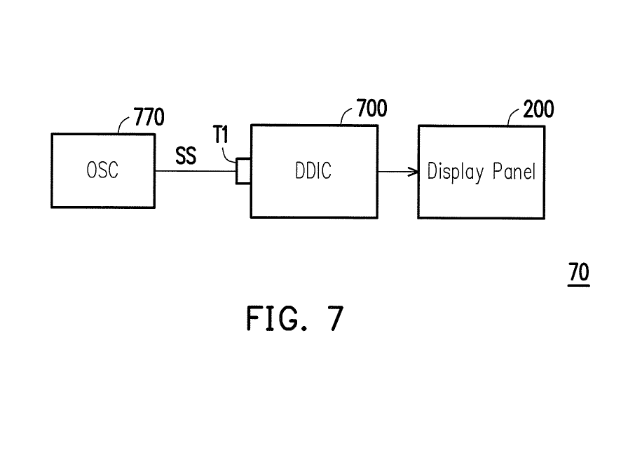

As described in the previous exemplary embodiments, the subscribed signal SS is received from an external source. FIG. 7 illustrates a display system of an electronic device 70 in term of functional block diagram according to one of the exemplary embodiments of the disclosure. In the exemplary embodiment, the electronic device 70 includes a DDIC 700, a display panel 200, and an oscillating device 770. The DDIC 700 is coupled to the oscillating device 770 to receive the subscribed signal SS through a first input terminal T1. The DDIC 700 generates display data according to the subscribed signal SS as to update the information displayed on the display panel 200. The structure and operation of the DDIC 700 are similar to the exemplary DDIC 100 illustrated in FIG. 2. Thus, the detail description of the DDIC 700 is not being repeated here.

In one of the exemplary embodiments of the disclosure, the external source may be the processor 300. In other words, the processor 300 may provide an oscillating signal as the subscribed signal SS to the DDIC 700 through the first input terminal T1, so that the DDIC 700 may render the subscribed information and generate the display data without obtaining frame data from the processor 300.

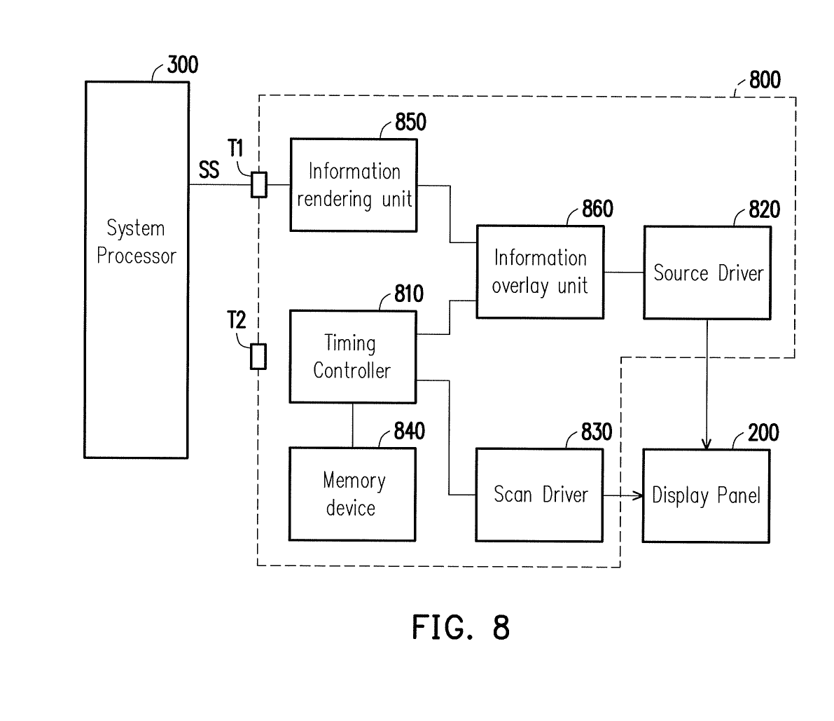

In one of the exemplary embodiments of the disclosure, the subscribed signal SS may be a command or instruction to update the display data according to the subscribed signal SS. FIG. 8 illustrates a DDIC 800 in term of functional block diagram according to one of the exemplary embodiments of the disclosure. The exemplary DDIC 800 includes a timing controller 810, a source driver 820, a scan driver 830, a memory device 840, an information rendering unit. 850, and an information overlay unit 860. The operations of the timing controller 810, the source driver 820, the scan driver 830, the memory device 840, and the information overlay unit 860 are similar to the timing controller 110, the source driver 120, the scan driver 130, the memory device 140, and the information overlay unit 160 illustrated in FIG. 2, and thus the detail description of which are not being repeated here.

In the exemplary embodiment, a command or instruction such as “add 1” or “subtract 1” may be transmitted from the processor 300 as the subscribed signal SS. According to the command, the information rendering unit 850 may render subscribed information in response to the received command. For example, the processor 300 may transmit an “add 1” command for every elapse of one minute to indicate an update of the time information shown the display panel 200 is required. Accordingly, the DDIC 800 may be triggered to render the subscribed information and generate the display data for updating the information shown on the display panel 200. In the exemplary embodiment, the processor 300 is operated in the power save mode.

It should be noted that, even in the power save mode, the processor 300 may still performs counting or simply calculation. For example, the processor 300 is a multi-cores processor, the graphic processing function may require all of the cores to be operational. However, for basic counting or simply calculation, the processor may only require one of the cores to perform basic functions leaving rest of the cores turned off. Thus, in the power save mode, some of the cores of the multi-cores processor may be turned off to conserve power.

Furthermore, the power consumption for transmitting a command or an oscillating signal would be much less than transmitting a frame data having information corresponding to every pixels of the entire display area of the display panel 200. Since the command or the oscillating signal has a much smaller package size, less transmission bandwidth is required as compared to the frame data. As a result, the power consumption of the electronic apparatus for transmitting the command or the oscillating signal is reduced.

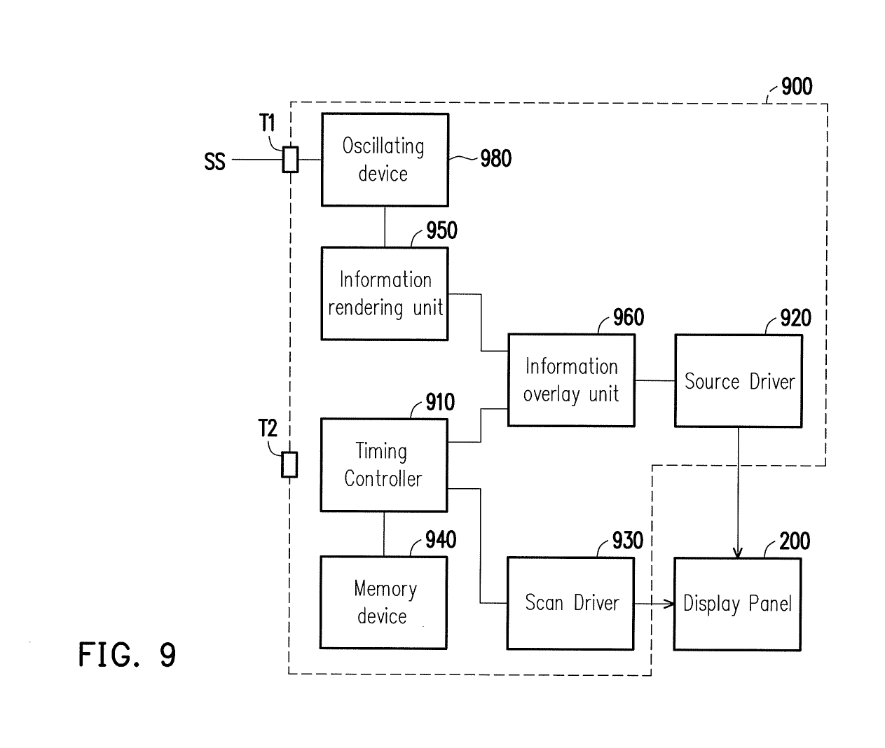

FIG. 9 illustrates a DDIC 900 in term of functional block diagram according to one of the exemplary embodiments of the disclosure. As compared to the exemplary DDIC 100 illustrated in FIG. 2, the DDIC 900 further includes an internal oscillating device 980, and the internal oscillating device 980 is coupled to a first input terminal T1 to receive a subscribed signal SS from an external source. In the exemplary embodiment, an oscillating signal outputted by the internal oscillating device 980 acts as an internal clock. The subscribed signal SS (e.g., an external oscillating signal, a command, or an instruction) is utilized for synchronization of the internal clock. An information rendering unit 950 is coupled to the internal oscillating device 980 to receive the internal clock. Accordingly, the subscribed information may be rendered.

The exemplary DDIC 900 includes a timing controller 910, a source driver 920, a scan driver 930, a memory device 940, and an information overlay unit 960. The operation of the timing controller 910, the source driver 920, the scan driver 930, the memory device 940, and the information overlay unit 960 are similar to the timing controller 110, the source driver 120, the scan driver 130, the memory device 140, and the information overlay unit 160 illustrated in FIG. 2, and thus the detail description of which are omitted here.

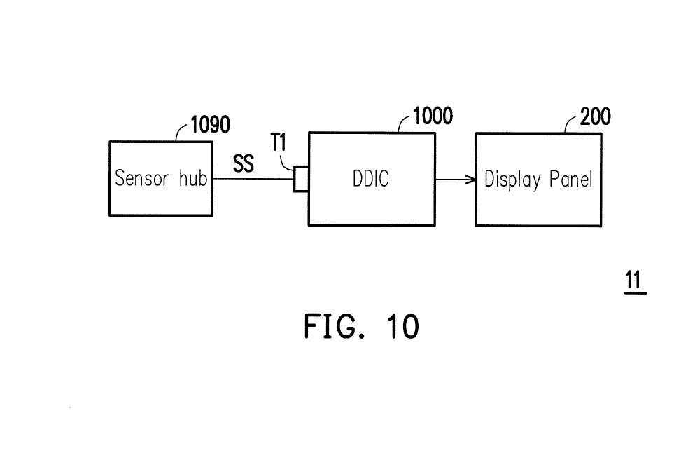

FIG. 10 illustrates a display system of an electronic apparatus 11 in term of functional block diagram according to one of the exemplary embodiments of the disclosure. In the exemplary embodiment, the electronic apparatus 11 includes a sensor hub 1090, a DDIC 1000, and a display panel 200. The DDIC 1000 is coupled to the sensor hub 1090 to receive a subscribed signal SS through a first input terminal T1. However, the disclosure is not limited thereto, the sensor hub 1090 may be coupled to the DDIC 1000 through a processor according to one of the exemplary embodiments, and the processor may process or simply forward the subscribed signal SS to the DDIC 1000. Similar to the exemplary embodiments described above, the DDIC 1000 renders subscribed information according to the subscribed signal SS, and then generates the display data according to the subscribed information. The processes of rendering the subscribed information and the generation of the display data are similar to the exemplary embodiments described above, thus the detail description of which are omitted here.

In the exemplary embodiment illustrated in FIG. 10, the subscribed signal SS is provided by the sensor hub 1090 which is coupled to various sensors such as an accelerometer (not shown), a gyroscope (not shown), a magnetometer (not shown), a Global Positioning System (GPS) sensor (not shown), a biosensor (not shown), temperature sensor (no shown) and the likes. In response to various signals of the sensors, the sensory hub 1090 may convert or translate the signals received from the sensors and transmit subscribed signal SS carrying information regarding the signals to the DDIC 1000 for generating the display data to update the information shown on the display panel 200. In one of the exemplary embodiments, the sensor hub 1090 may simply forward the signal outputted by the sensors.

For example, the biosensor may be a heart rate sensor. The heart rate sensor may detect a heart rate of a user and transmit a sensory signal to the sensor hub 1090. According to the sensory signal, the sensor hub 1090 may generate and transmit the subscribed signal SS to the DDIC 1000 to update the information shown on the display panel 200 which would be heart rate information. The operation of the DDIC 1000 are similar to the exemplary DDIC 100 illustrated in FIG. 2 for rendering the subscribed information and generation of the display data, thus the detail description of the DDIC 1000 is not being repeated here. In the exemplary embodiment, the electronic apparatus 11 may be configured to update the heart rate information shown on the display panel 200 according to an update rate (i.e., the first update rate). For example, the heart rate information may be configured to be updated every 30 seconds, 1 minute, etc.

In one of the exemplary embodiments of the disclosure, the information shown on the display panel 200 may a GPS coordinate of the current location. In one of the exemplary embodiments of the disclosure, the information shown on the display panel 200 may be a compass having a heading direction and degrees that are represented by geometric shapes (e.g., arrows) and characters.

In view of aforementioned description, the disclosure provides a display driver integrated circuit (DDIC) and an electronic apparatus therewith. The DDIC generates display data to constantly update and display information shown on a display panel without constantly obtaining frame data from a processor that is external to the DDIC. The DDIC would synthesize the display data according to rendered subscribed information and a background image. As a result, information shown on the display panel display data may be updated based on the subscribed information even when the processor is in a sleep mode, power save mode, standby mode or the likes, where the graphical process of the processor is suspended.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display driver integrated circuit (DDIC), configured to drive a display panel, comprising:
a first input terminal, receiving a subscribed signal;
a memory device, storing a background image;
an information rendering unit, coupled to the first input terminal, receiving the subscribed signal, and rendering subscribed information according to the subscribed signal;
an information overlay unit, receiving the subscribed information and the background image, and generating display data according to the subscribed information and the background image; and
a source driver, coupled to the information overlay unit and the display panel, receiving the display data and driving data lines of the display panel according to the display data.

2. The DDIC of claim 1, wherein the background image is pre-stored in the memory device.

3. The DDIC of claim 1, further comprising:
a second input terminal, receiving a frame data; and
a timing controller, coupled to the second input terminal, the memory device, and the information overlay unit, controlling timing sequence of the data lines of the display panel, and storing the frame data to the memory device as the background image,
wherein the display data is different from the frame data,
wherein the display data is updated at a first rate, and the background image is updated by the frame data at a second rate, and the first rate is different from the second rate.

4. The DDIC of claim 1, wherein the information overlay unit determines a portion of the background image to be updated and generates the display data by overlaying the subscribed information over the portion of the background image.

5. The DDIC of claim 1, wherein the information rendering unit obtains a graphical representation of the subscribed information through a lookup table according to the subscribed signal.

6. The DDIC of claim 1, wherein the subscribed signal is an oscillating signal.

7. The DDIC of claim 6, further comprising an internal oscillating device generating an internal oscillating signal, wherein the internal oscillating device is synchronized according to the subscribed signal, and wherein the subscribed information is rendered according to the internal oscillating signal.

8. The DDIC of claim 1, wherein the subscribed signal is a command instruction, and the information rendering unit renders the subscribed information in response to the command instruction.

9. The DDIC of claim 1, wherein the subscribed signal is sensing signal.

10. An electronic apparatus, comprising:
a processor;
a display panel; and
a display driver integrated circuit (DDIC), coupled to the processor and the display panel, rendering subscribed information according to a subscribed signal, generating display data according to the subscribed information and a background image, and driving data lines of the display panel according to the display data.

11. The electronic apparatus of claim 10, wherein the DDIC generates the display data by overlaying the subscribed information over a portion of the background image stored in a memory device disposed in the DDIC.

12. The electronic apparatus of claim 11, wherein the display data is generated by the DDIC only based on the rendered subscribed information and the background image pre-stored in the memory device.

13. The electronic apparatus of claim 10, wherein frame data is transmitted from the processor to the DDIC and stored as the background image, wherein the display data is updated with a first rate and the background image is updated by the frame data with a second rate, and the first rate is different from the second rate.

14. The electronic apparatus of claim 10, wherein the DDIC renders a graphical representation of the subscribed information by inquiring a lookup table according to the subscribed signal.

15. The electronic apparatus of claim 10, wherein the subscribed signal is an oscillating signal.

16. The electronic apparatus of claim 10, the DDIC, further comprising an internal oscillating device generating an internal oscillating signal, wherein the internal oscillating device is synchronized according to the subscribed signal, and wherein the subscribed information is rendered according to the internal oscillating signal.

17. The electronic apparatus of claim 10, wherein the subscribed signal is a command instruction, and the information rendering unit renders the subscribed information in response to the command instruction.

18. The electronic apparatus of claim 10, further comprising:
a sensor hub, coupled to the DDIC, providing sensing signal from a plurality of sensors to the DDIC as the subscribed signal, wherein the DDIC generates the subscribed information according to the sensing signal.

19. The electronic apparatus of claim 10, wherein the processor is operated in a power save mode with graphic processing function disabled.
